(19) United States
(12) Patent Application Publication
(10) Pub. No.: US 2015/0149551 A1
(43) Pub. Date: May 28, 2015

(54) INFORMATION SHARING SYSTEM

(71) Applicant: DIGITAL ACOUSTIC CORPORATION, Osaka (JP)

(72) Inventors: Naofumi SHIMAZAKI, Osaka (JP); Munehiro YONEDA, Osaka (JP); Kenji KOSAKA, Osaka (JP); Daisuke SHINOHARA, Osaka (JP)

(21) Appl. No.: 14/547,476

(22) Filed: Nov. 19, 2014

(30) Foreign Application Priority Data
Nov. 28, 2013 (JP) 2013-246125

(51) Int. Cl. H04L 29/08

(52) U.S. Cl. CPC H04L 67/104
USPC 709/204

(57) ABSTRACT

A plurality of devices are connected to a network and are controlled by a plurality of controllers, information is efficiently shared so that the control using the controllers is made to be easy.

Any one of the devices is set as a host device and it distributes identical share information to another device. When a controller is connected to any device and this device is connected to a service server, the device is registered as a source device in the share information. When another controller is connected to any device other than the source device, this device refers to the share information so as to specify the source device and register account information of another controller as share information. The source device is connected to the service server by using account information in the share information.

### BACKGROUND OF THE INVENTION

1. Field of the Invention

The present invention relates to an information sharing system. The invention particularly relates to an information sharing technique in a plurality of controllers and a plurality of devices.

2. Description of the Related Art

A system in which a plurality of devices are connected to a network and any one of the devices is connected to a service server via an internet so as to download music or the like has been developed. In case that a device that accesses to a service server so as to transmit/receive data to/from the service server is set as a source device, a user controls an operation of the source device using a controller so as to be capable of controlling the system.

Japanese Patent Application Laid-Open No. 2000-125366 describes that when an operation screen is changed by a state change inside a device in a network control system, the state change can be notified to the controller quickly and thus the controller and the device can share identical state information surely. The controller issues a screen request so as to obtain screen display data from the device and transmits operation information and identification information of the screen display data to the device when an operation is performed on an operation screen. The device executes a function corresponding to this operation request and when the screen display data is changed, it transmits the changed screen display data to the controller.

A specific device of the plurality of devices is determined as a source device in a fixed manner, and information is easily shared in a system where this specific device is connected to the controller, but it is difficult to share information in a system where the controller can be connected to devices other than the source device. The above problem may be actualized particularly in a system where the plurality of devices are connected to a network, a server that uniformly manages information on the network is not present, and a plurality of controllers are connected to any devices to perform control.

### SUMMARY OF THE INVENTION

It is an object of the present invention to share information efficiently and facilitate control using a controller in the case where a plurality of devices are connected to a network and a plurality of controllers controls the devices.

An information sharing system without a server comprising: a plurality of network devices, wherein each of the plurality of network devices includes a processor, a storage unit, and a communication interface, identical share information is stored in each of the storage units of the plurality of network devices, when a first controller in a plurality of controllers is connected to a first network device of the plurality of network devices, the processor of the first network device connects to a service server, and distributes source device information representing the connection to the service server as share information to another network device via the communication interface, when the second controller of the plurality of controllers is connected to a second network device of the plurality of network devices, the processor of the second network device reads the source device information as the share information from the storage unit, and processes a request from the second controller.

In the present invention, a processor of a first network device distributes source device information representing that connection with a service server as share information to another network device. For this reason, a processor of another network device can easily detect the source device. When the controller is connected to a second network device that is not the source device and a request is received from the controller, the processor of the network device can transmit the request to the source device. According to the present invention, information (source device information) is shared efficiently, so that the request from the controller can be processed efficiently.

Preferably, wherein the processor of the second network device distributes account information of the second controller as share information to another network device, and when receiving a request of connection to the service server from the second controller, the processor transmits the request of the connection to the service server to the first network device based on the source device information as the share information, when receiving the request of connection to the service server from the processor of the second network device, the processor of the first network device makes the connection to the service server using the account information of the second controller as the share information.

In the present invention, the processor of the first network device is connected to the service server using account information of a second controller as share information. For this reason, the controller is connected to any device so as to be capable of being connected to the service server.

Preferably, wherein when receiving a screen request from the second controller, the processor of the second network device transmits the screen request to the first network device based on the source device information as the share information, when receiving the screen request from the processor of the second network device, the processor of the first network device transmits screen information transmitted to the first controller to the second network device.

In the present invention, the processor of the first network device transmits screen information transmitted to a first controller to a second network device. For this reason, a controller can share a screen displayed on another controller. As a result, a user can visually recognize the screen, which is the same as that of the controller connected to the source device, on a controller connected to any network device.

Preferably, wherein the processor of any device of the plurality of network devices distributes information stored in the storage unit as share information to another device via the communication interface.

In the present invention, the processor of any one of the plurality of network devices distributes information stored in a storage unit as share information to another network device. As a result, the identical share information can be stored in the storage units of the plurality of network devices.

### BRIEF DESCRIPTION OF THE DRAWINGS

FIG. 1 is a system structural diagram according to an embodiment;

FIG. 2 is an explanatory diagram illustrating generation of a device list using a UDP broadcast function;

FIG. 3 is an explanatory diagram after a host device is set;

FIG. 4 is an explanatory diagram illustrating distribution of plan data;

FIG. 5 is an explanatory diagram illustrating collection of share information (temporary share information);

FIG. 6 is an explanatory diagram illustrating collection of share information (temporary share information);

FIG. 7 is a flowchart illustrating a processing operation for determining whether merged share information in a device other than the host is proper;

FIG. 8 is a flowchart illustrating processing for collecting the share information in the host device;

FIG. 9 is an explanatory diagram of distribution of share information;

FIG. 10 is an explanatory diagram (1) illustrating an access to a service serve;

FIG. 11 is an explanatory diagram (2) illustrating the access to the service server; and

FIG. 12 is an explanatory diagram illustrating share of screen information.

### DETAILED DESCRIPTION OF PREFERRED EMBODIMENTS

An embodiment of the present invention is described below with reference to the drawings.

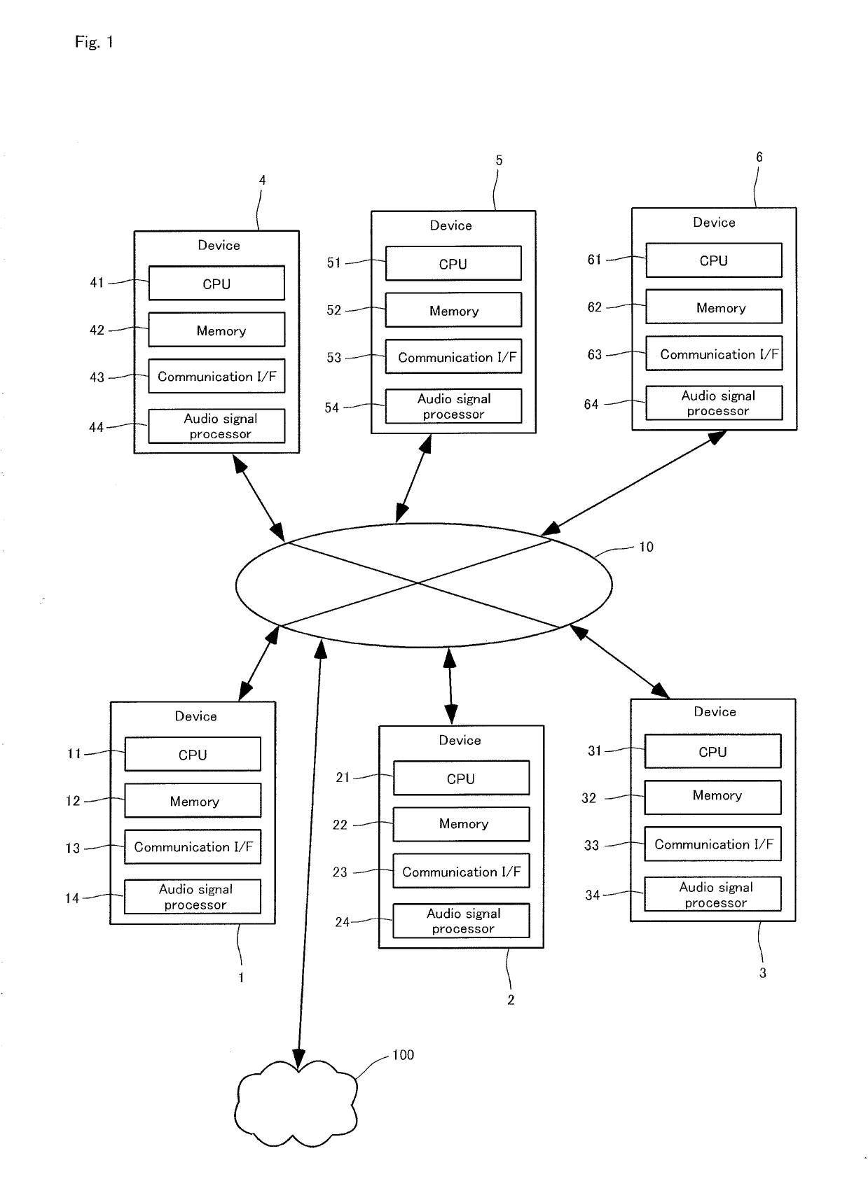

FIG. 1 is an entire structural diagram of a network system according to the first embodiment. A plurality of network devices 1, 2, 3, 4, 5, and 6 are connected to a network 10. The drawing illustrates totally six devices, but the number of the devices is not limited to this. The devices each may have the same configuration or different configurations. The network devices mean devices that are connected to each other via a communication line (the network 10) so as to structure a network system and can transmit/receive data. The communication line may be wired or wireless. Further, the typical examples of the network device include information devices such as computers, personal computers, tablet terminals, mobile telephones, and also audio visual (AV) apparatuses and audio apparatuses that can be connected to each other via a communication line. FIG. 1 illustrates an audio apparatus that reproduces audios as devices 1 to 6. The devices each may have different configurations, but they have the same configuration in the present embodiment and the configuration of only the device 1 is described.

The device 1 includes a CPU 11 (a processing unit), a memory 12 (storage unit), a communication interface (I/F) 13, and an audio signal processor 14.

The memory 12 includes a program memory and a working memory. Programs that are executed by the CPU 11 are stored in the program memory. A device list described later and the like are stored in the working memory.

The CPU 11 executes processing described later according to the programs stored in the program memory so as to execute processing for specifying a device to be a host device (hereinafter, simply “host”) from the plurality of devices 1 to 6. Further, after the host device is set, the CPU 11 structures a network system among the plurality of devices 1 to 6, and executes a series of processing for sharing necessary information.

The communication I/F 13 transmits/receives various data such as a device list retained in the device 1 via the network 10. The CPU 11 transmits/receives various data via the communication I/F 13, but for easy description, “the CPU 11 transmits a device list” from which “via the communication I/F 13” is omitted is used hereinafter.

The audio signal processor 14 executes predetermined processing such as demodulating and amplifying on input audio signals. In case that the device 1 is a speaker, the audio signal processor includes a driver circuit for outputting an audio signal. In case that the device 1 is an amplifier and a speaker, the audio signal processor 14 includes a demodulating circuit, an amplifying circuit, and a driver circuit.

Another device such as a CD player or a DVD player may be connected to the device 1.

Further, the network 10 is typically LAN (Local Area Network), but the network 10 is connected to WAN (Wide Area Network), and may be connected to a specific service device via WAN. The network 10 may be a wired network or a wireless network.

In FIG. 1, any of the plurality of devices 1 to 6 does not function as a host in an initial state, and thus no host is present. In this initial state, the devices 1 to 6 are connected to the network 10, but the devices 1 to 6 are not connected to each other. That is to say, the network system is not structured by the devices 1 to 6. From this state, the devices 1 to 6 transmit/receive data among the devices 1 to 6 and autonomously set any one device as the host so as to structure a set host-based network system. The devices 1 to 6 structuring the network system share information.

The processing for autonomously setting the host device in the initial state that the host device is not set is described below.

### <Setting the Host Device>

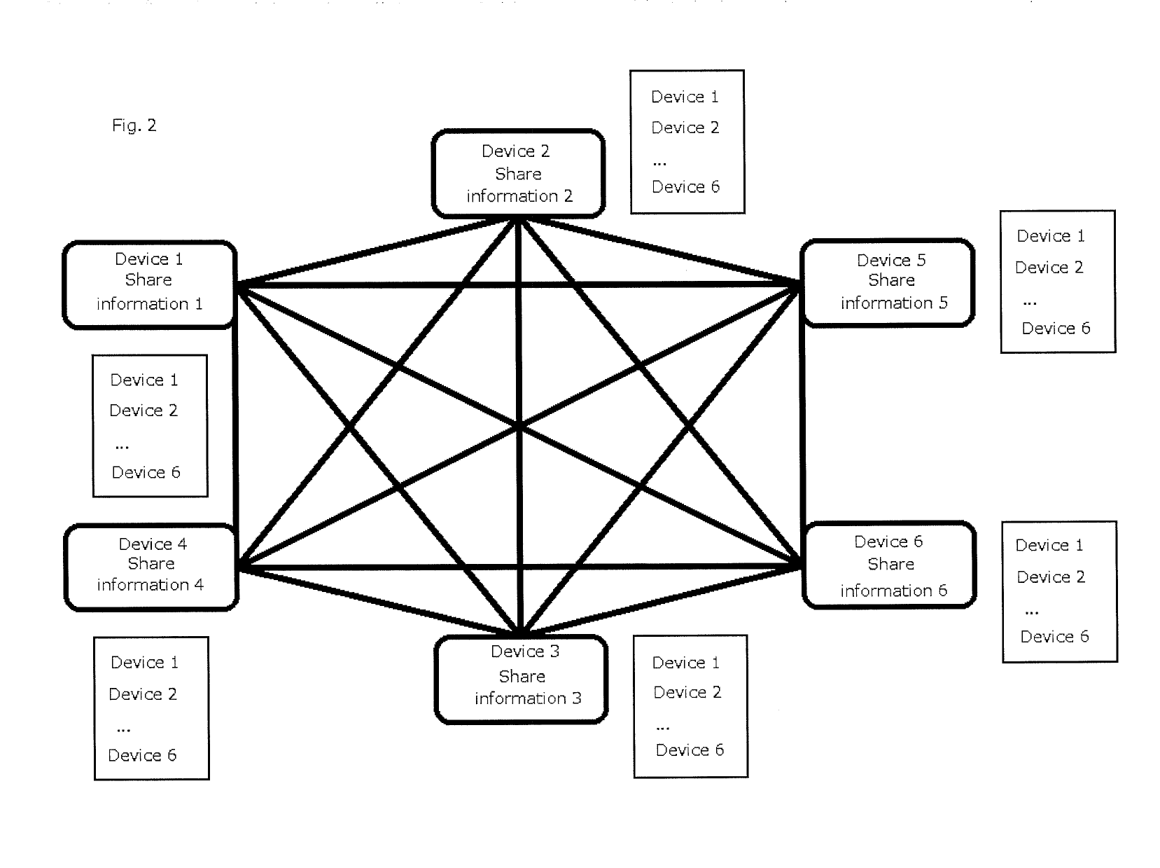

FIG. 2 illustrates a state that the devices 1 to 6 are each connected to the network 10 by the communication I/Fs 13 to 63. When the devices 1 to 6 are powered on, CPUs 11 to 61 of the devices 1 to 6 obtain device lists including the approximately same contents using a UDP (User Datagram Protocol) broadcasting function, and store the obtained device lists in memories 12 to 62, respectively. “The approximately same contents” means that the contents do not have to completely match with each other, and a case where an echo could not return because of an unstable communication state is taken into consideration.

This broadcast function enables the devices 1 to 6 to retain the lists of the devices connected to the network 10 as well as share information and scheme information. For example, the device 1 stores share information 1, scheme information, and also the device list (the device 1, the device 2, and so on) in the memory 12. Further, the device 2 stores share information 2, scheme information, and also the device list (the devices 1, 2, and so on) in the memory 22. In the initial state, there is no guarantee that the share information, the scheme information, and the device lists retained in the respective devices 1 to 6 are the same as each other, and there is no guarantee that the share information 1 and the share information 2 are the same as each other (although the information are “share information”, there is no guarantee that the information is always shared by all the devices 1 to 6 in the initial state, and thus it may be temporary share information). The share information is information shared among the devices. Further, the scheme information is information about scheme (framework) for determining whether the share information has a proper form, format and value. The share information and the scheme information are always transmitted/received in a set.

UDP is a protocol that is used for transmitting a message “datagram” to another computer on an Internet Protocol (IP) network, and has an advantage that a transfer channel and a data route do not have to be specially set in advance.

When obtaining the device lists, the CPUs 11 to 61 of the devices 1 to 6 each determine whether a self device is proper as a host among the devices 1 to 6 based on the device lists stored in the memories 12 to 62, respectively. As described above, no host is present in the initial state, but if a host is present, the CPUs 11 to 61 of the devices 1 to 6 do not make the determination and regard the existent host as the host. Further, In case that another device that returns an echo is also the host although a result of the determination is that the self device is proper as the host (host conflict), the CPUs 11 to 61 of the devices 1 to 6 determine which of the self device or another device is proper as the host. In case that the CPUs 11 to 61 determine that the self device is proper as the host, they transmit a message representing that the host is already present to another device. Details of the determination are described later.

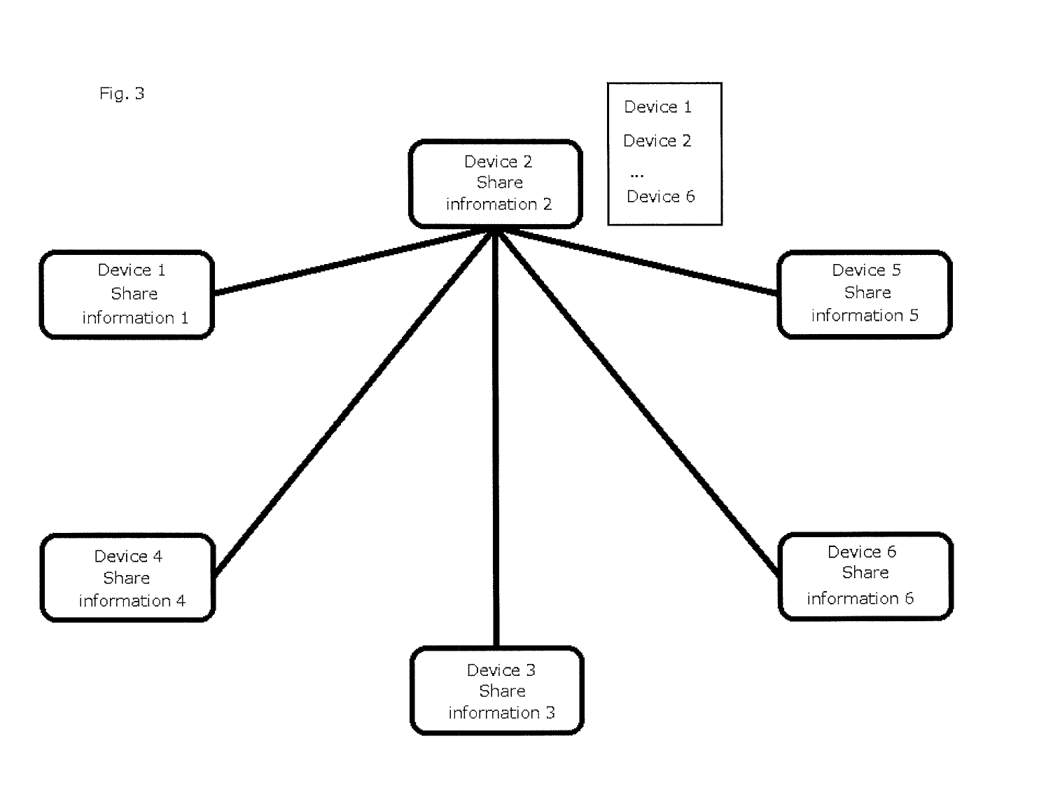

FIG. 3 illustrates a case where the determination is made that the CPU 21 of the device 2 is proper as the host as a result of determining whether the self device is proper as the host in the CPUs 11 to 61 of the devices 1 to 6. In case that the device 2 is set as the host, the CPU 21 of the device 2 as the host reads the device list form the memory 22 and attaches the read device list to an echo message so as to transmit it to the other devices 1 and 3 to 6. The CPUs 11 and 31 to 61 of the devices 1 and 3 to 6 other than the host interrupt search with the echo, and receive the device list included in the echo message of the device 2 so as to store the received device list in the memories 12 and 32 to 62. That is to say, as shown in FIG. 3, only the device 2 as the host broadcasts and distributes the retained device list to the other devices 1 and 3 to 6. As a result, all the devices 1 to 6 retain the same device list.

When an echo is not transmitted from the device 2 as the host for a certain period of time, the CPUs 11 and 31 to 61 of the devices 1 and 3 to 6 other than the host start to search for an echo. Further, when a certain period of time further passes, next host is again set.

### <Generation and Distribution of Plan Data>

The CPU 21 of the device 2 as the host, as shown in FIG. 3, distributes the device list stored in the memory 22 to the other devices 1 and 3 to 6. The CPU 21, in parallel with this, generates network plan data (hereinafter, simply “plan data”) that is plan data of the network system using the device list stored in the memory 22 (namely, retained by all the devices 1 to 6). The CPU 21 connects the self device 2 to a device in a hierarchy one level down (the nearest client) in the generated plan data and transmits the generated plan data.

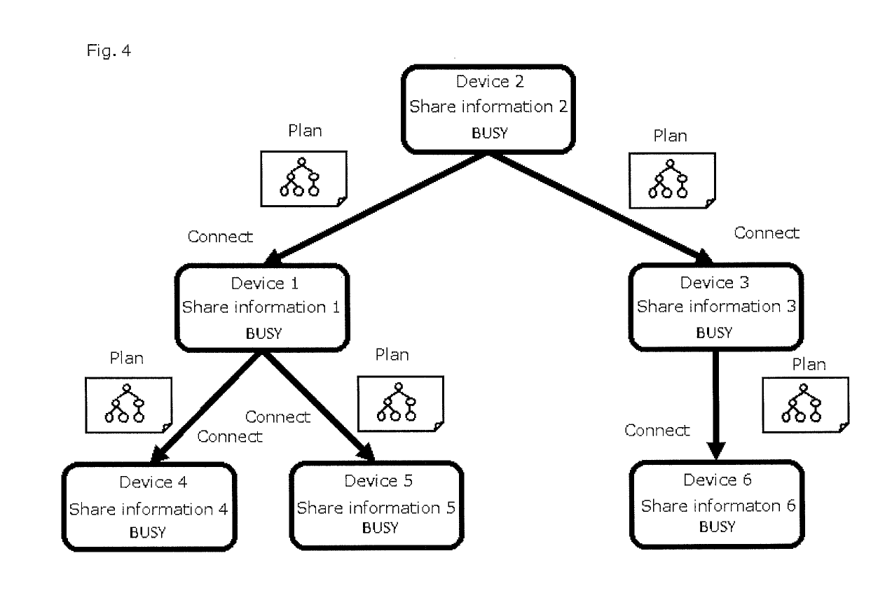

FIG. 4 illustrates a configuration where the plurality of devices 1 to 6 is connected into a binary tree shape in which the host is at the top as the network plan data. The device 2 as the host is at the top, and the device 1 and the device 3 are connected below the device 2. The device 4 and the device 5 are connected below the device 1, and the device 6 is connected below the device 3. The plan data is a data string where such a connecting relationship is described. The devices 1 to 6 are each connected to necessary devices according to the generated plan data so as to structure the network system. As shown in FIG. 4, the network system according to the present embodiment includes the host device, and the client devices (hereinafter, simply “clients”) connected to the host device, and has a hierarchical structure where the host device is at the top.

The CPU 21 of the device 2 as the host connects the self device to the device 1 and the device 3 that are the clients according to the plan data, and transmits the generated plan data. The CPU 11 of the device 1 receives the plan data from the device 2, and stores the received plan data in the memory 12. The CPU 11 connects the self device to the device 4 and the device 5 according to the plan data, and transmits the received plan data. The CPU 41 of the device 4 and the CPU 51 of the device 5 store the received plan data in the memories 42 and 52, respectively. Further, the CPU 31 of the device 3 receives the plan data from the device 2, and stores the received plan data in the memory 32. The CPU 31 connects the self device to the device 6 according to this plan data, and transmits the received plan data. The CPU 61 of the device 6 stores the received plan data in the memory 62. The CPUs 41 to 61 of the device 4 to 6 determine that the self devices are in the lowest hierarchy in the network system according to the received plan data.

### <Collection and Distribution of Share Information>

After the device is connected according to the plan data generated by the host device so that the network system is structured, the device 2 as the host collects share information (temporary share information) retained by the other devices 1 and 3 to 6.

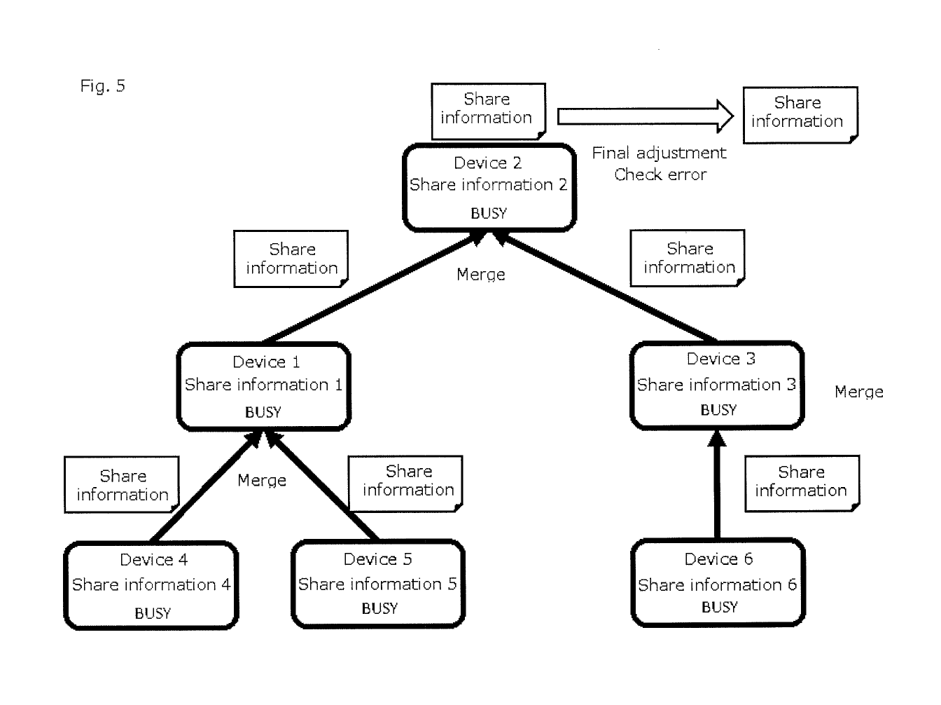

FIG. 5 illustrates the processing for collecting the share information. The CPU 21 of the device 2 as the host transmits a command for collecting share information to the other devices 1 and 3 to 6. Concretely, the CPU 21 of the device 2 transmits the collecting command to the device 1 and the device 3 as the clients. The CPU 11 of the device 1 transmits the collecting command to the device 4 and the device 5 as the clients. The CPU 31 of the device 3 transmits the collecting command to the device 6 as the client.

When the CPUs of the devices each receive the collecting command, they read the share information stored in the memories (retained by the self devices) according to the command, and transmit the read share information to devices in a hierarchy one level up. Each of the CPUs of the device in a hierarchy one level up that receives the share information from each of the clients transmits the received share information to each of devices in a hierarchy one level up. At this time, when the share information is stored in each of the memories, each of the CPUs merges (synthesizes) the share information stored in the memory and the share information received from each of the clients so as to transmit the merged information to each device in a hierarchy on level up.

That is to say, the CPU 41 of the device 4 transmits share information 4 stored in the memory 42 to the device 1. Further, the CPU 51 of the device 5 transmits share information 5 stored in the memory 52 to the device 1. The CPU 11 of the device 1 merges the share information 4 with the share information 5, and further merges the share information 1 stored in the memory 12 with them, so as to transmit the share information 1+the share information 4+the share information 5 to the device 2. Further, the CPU 61 of the device 6 transmits the share information 6 stored in the memory 62 to the device 3. The CPU 31 of the device 3 merges the share information 3 stored in the memory 32 and the share information 6, and transmits the share information 3+the share information 6 to the device 2.

Each of the CPU of each device, which merges share information transmitted from each device in a hierarchy one level down with the share information stored in each of the memories and transmits the merged share information to each of the devices in a hierarchy one level up, merges the share information, and determines based on the scheme information whether the merged share information (temporary share information) is proper, namely, the merged share information and the scheme information match with each other. In case that the CPUs of the devices each determines that the merged share information (temporary share information) is proper, namely, the merged share information matches with the scheme information based on the scheme information, it transmits the merged share information to each of the devices in a hierarchy one level up. On the other hand, in case that the CPUs of the devices each determine that the merged share information is not proper, namely, the merged share information does not match with the scheme information, it discards the merged share information. For example, after the CPU 11 of the device 1 merges the share information 4, the share information 5, and share information 1, it determines whether the merged share information (temporary share information) is proper based on the scheme information. In case that the CPU 11 of the device 1 determines that the merged share information (temporary share information) is proper based on the scheme information, it transmits the merged share information to the device 2. That the merged share information is proper means that the merging of the share information succeeds. Further, that the merged share information is not proper means that the merging of the share information fails.

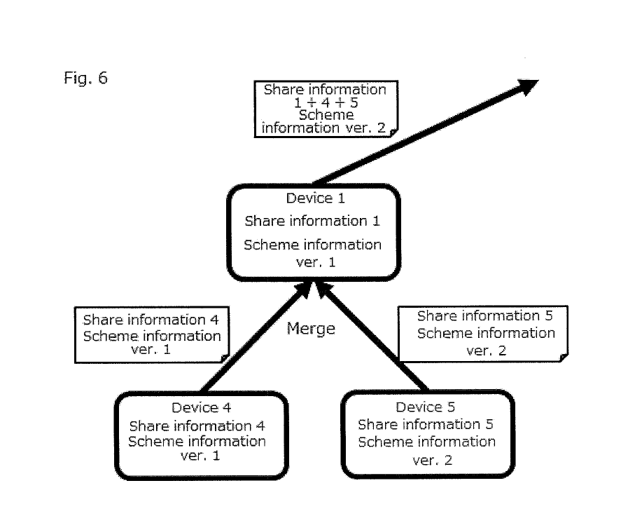

Further, the CPUs of the devices each transmit a set of the share information and the scheme information. For example, as shown in FIG. 6, the CPU 41 of the device 4 transmits the share information 4 stored in the memory 42 and scheme information of version 1 to the device 1. The CPU 51 of the device 5 transmits the share information 5 and scheme information of version 2 to the device 1. Further, in case that the version of the received scheme information is newer than the version of the scheme information stored in the memory, the CPUs of the devices each transmits the scheme information of the new version to a device in a hierarchy one level up. For example, as shown in FIG. 6, the CPU 11 of the device 1 transmits the scheme information of version 2 that is newer than the scheme information of version 1 stored in the memory 12 to the device 2 in the hierarchy one level up.

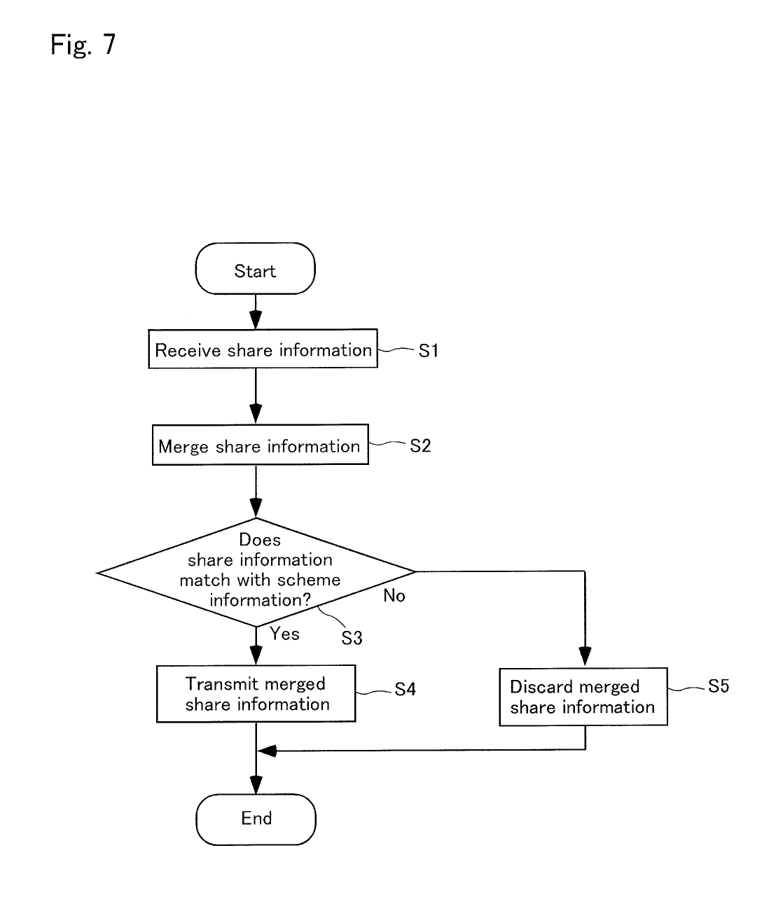

FIG. 7 is a flowchart illustrating a processing operation for determining whether merged share information in a device other than the host is proper. When the CPUs of the devices each receives share information transmitted from each device in a hierarchy one level down (S1), it merges the received share information with the share information stored in the memory (S2). Each of the CPUs determines whether the merged share information matches with the scheme information (S3). Incase that the CPUs each determine that the merged share information matches with the scheme information (S3: Yes), it transmits the merged share information and the scheme information to each of the devices in a hierarchy one level up (S4). In case that each of the CPUs determines that the merged share information does not match with the scheme information (S3: No), it discards the merged share information (S5).

The CPU 21 of the device 2 as the host receives the share information 1+the share information 4+the share information 5 from the device 1 and the share information 3+share information 6 from the device 3, merges them and further merges also the share information 2 stored in the memory 22 so as to generate

the share information=the share information 1+the share information 2+the share information 3+the share information 4+the share information 5+the share information 6. The CPU 21 of the device 2 determines whether the merged share information (temporary share information) is proper based on the scheme information, namely, the merged share information matches with the scheme information. In case that the CPU 21 of the device 2 determines that the merged share information (temporary share information) is proper based on the scheme information, namely, the merged share information matches with the scheme information, it stores the merged share information in the memory 22. Therefore, the memory 22 of the device 2 updates the share information 2 into new share information. In case that the CPU 21 of the device 2 determines that the merged share information (temporary share information) is not proper based on the scheme information, namely, the merged share information does not match with the scheme information, it discards the merged share information.

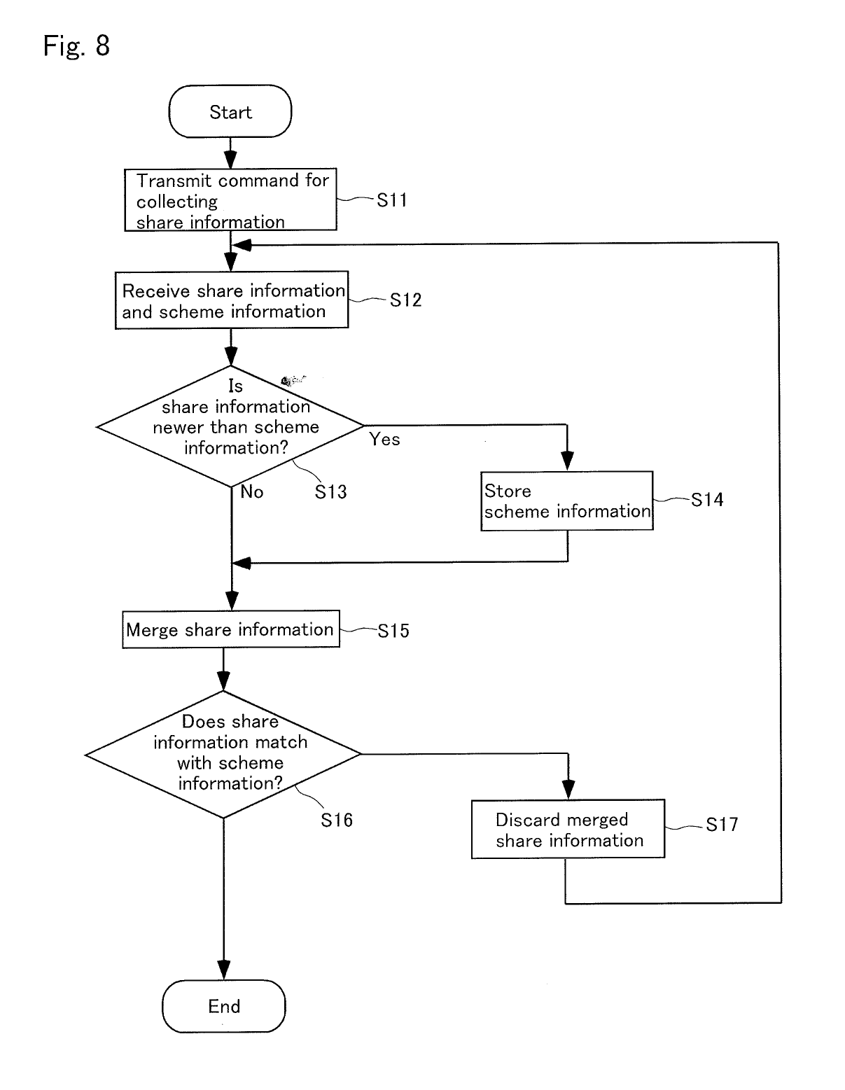

FIG. 8 is a flowchart illustrating processing for collecting the share information in the host device. The CPU of the host device transmits the command for collecting the share information to a device in a hierarchy one level down (S11). Thereafter, the CPU receives the share information and the scheme information from the device in the hierarchy one level down (S12). The CPU then determines whether the version of the received scheme information is newer than the version of the scheme information stored in the memory (S13). In case that the CPU determines that the version of the received scheme information is newer than the version of the scheme information stored in the memory (S13: Yes), it stores the received scheme information in the memory (S14). In case that the CPU determines whether the version of the received scheme information is not newer than the version of the scheme information stored in the memory (S13: No) or after processing in S14, it merges the received share information with the share information stored in the memory (S15). The CPU determines whether the merged share information matches with the scheme information (S16). In case that the CPU determines that the merged share information does not match with the scheme information (S16: No), it discards the merged share information (S17). At this time, the CPU notifies a device in a hierarchy one level down of that the merged share information is not proper, namely, failure of the merging. The CPU of the device in the hierarchy one level down again merges the received share information with the share information stored in the memory. In case that the merged shared information is proper, the CPU of the device in the hierarchy one level down again transmits the merged share information to a device in the hierarchy one level up. On the other hand, in case that the merged share information is not proper, the CPU of the device in the hierarchy one level down notifies a device in the hierarchy one level down of improperness of the merged share information, namely, failure of the merging. In such a manner, the merging of share information is performed again in each of the devices, and the merged share information is eventually transmitted to the host device.

The CPU of the host device again executes the processing in S12 to S16 after the processing in S17. Further, in case that the CPU determines that the merged share information matches with the scheme information (S16: Yes), it ends the processing.

In case that share information that are retained by the devices 1 and 3 to 6 themselves is transmitted individually to the host device 2, communication traffic increases, and further a load on the CPU 21 of the host device 2 increases. Particularly since the devices 1 to 6 are not computers but acoustic devices such as amplifiers and speakers, the throughput of the mounted CPUs 11 to 61 are limited, and thus it is hard for the CPUs to process a number of pieces of data at one time. Like the present embodiment, when each of the CPUs of the devices structuring the network system merges share information from client devices and further merges share information retained in the self device so as to transmit the merged information to the device 2 collectively, the CPU of the device 2 only have to receive the share information transmitted from the two devices 1 and 3 and merges them with the self share information, so that the efficient collecting processing is enabled.

After the CPU 21 of the host device 2 generates share information (true share information common in all the devices) so as to store it in the memory 22, it reads share information (network share information) and the scheme information from the memory 22 so as to transmit them to the other devices 1 and 3 to 6. In the present embodiment, the CPU 21 of the device 2 transmits the share information and the scheme information only to the device 1 and the device 3 in the hierarchy one level down.

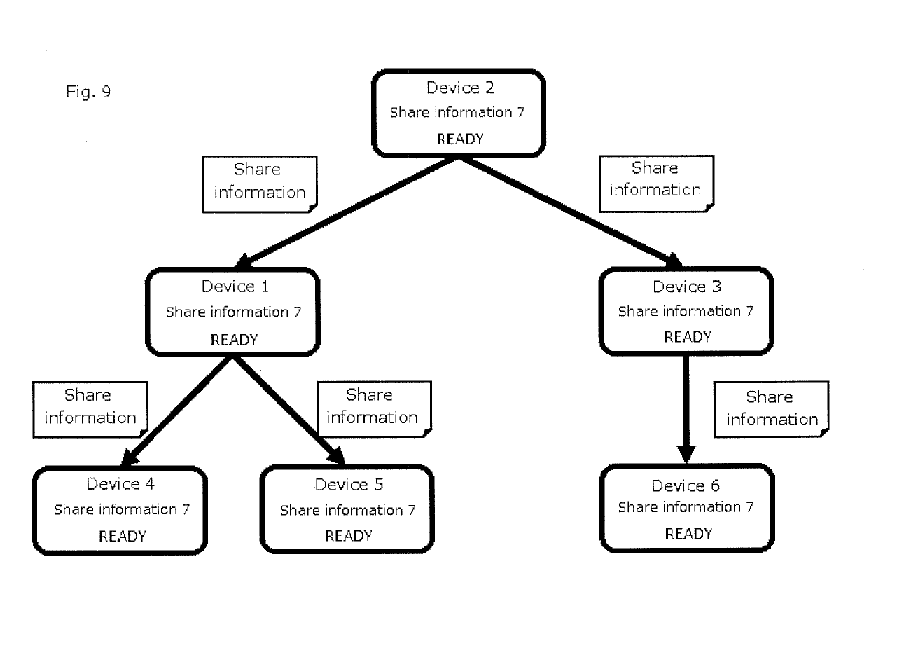

FIG. 9 illustrates processing for distributing share information (network share information). The CPU 21 of the device 2 transmits the generated share information and the scheme information of the latest version to the client devices 1 and 3. The CPU 11 of the device 1 stores the received share information and the scheme information in the memory 12 and transmits them to the client devices 4 and 5. The CPU 41 of the device 4 and the CPU 51 of the device 5 store the received share information and scheme information in the memories 42 and 52, respectively. Further, the CPU 31 of the device 3 stores the received share information and scheme information in the memory 32, and transmits them to the client device 6. The CPU 61 of the device 6 stores the received share information in the memory 62. As a result, all the devices 1 to 6 retain the same share information (this is share information 7) and the scheme information.

### <Sharing of Source Device Information and Account Information>

As shown in FIG. 9, all the devices 1 to 6 have the identical share information in the memories 11 to 61. That is to say, the configuration is equivalent to a configuration where a share database that stores the share information is connected to the network 10, and the devices 1 to 6 can access to the share database. The following describes a case where instead of the memories 11 to 61 of the devices 1 to 6, a single share database is connected to the network 10. Further, in order to simplify the description, instead of the devices 1 to 6, devices A, B, and C are connected to the network 10.

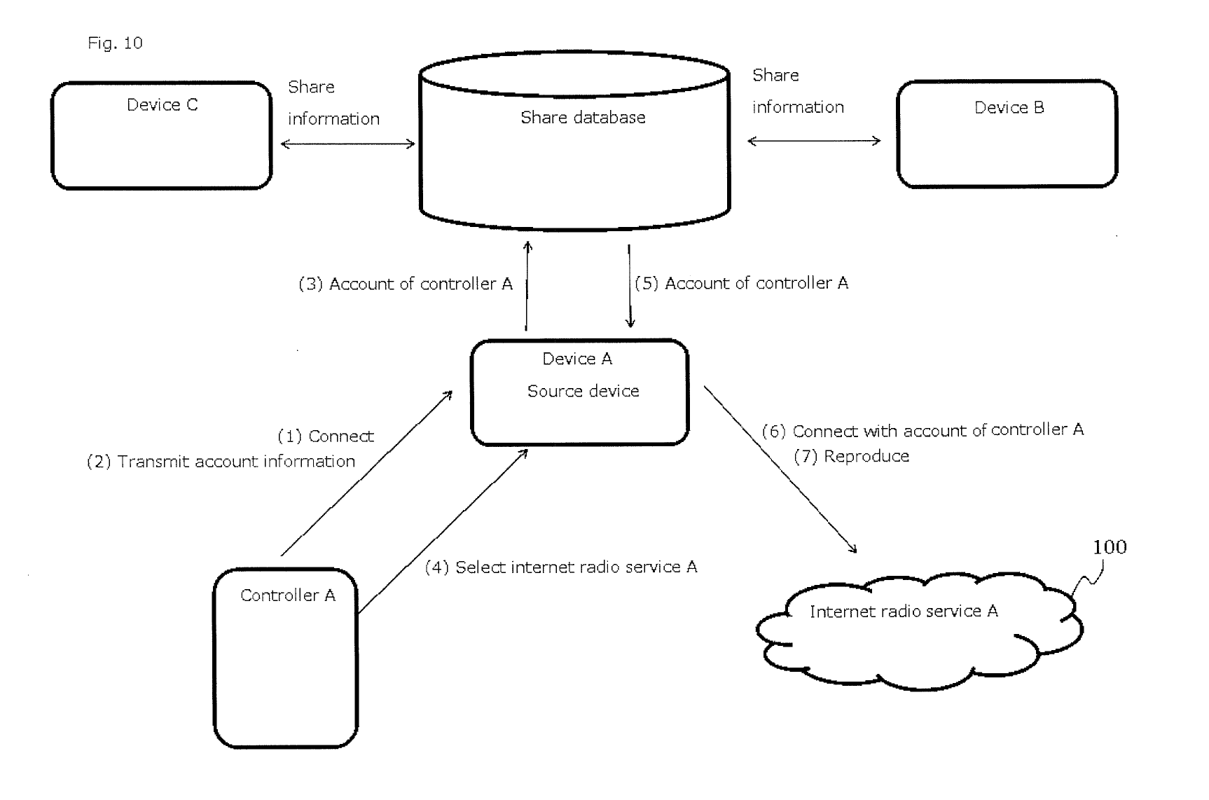

FIG. 10 illustrates a case where the device A of the devices A, B, and C functions as a source device that accesses to a service server 100 and downloads data from the service server 100. In this case, any one of the devices A, B, and C is set as the host device by the above-described processing, but the host device does not always have to function as the source device, and thus a client device may function as the source device. Further, the drawing illustrates an internet radio service A as the service server 100, but any service may be used.

A user connects a controller A to the device A as the source device and transmits account information of the controller A to the device A. The account information for accessing to services of the service server 100 is stored in a memory of the controller A in advance, and the controller A reads the account information from the memory so as to transmit it to the device A. Plural pieces of account information for accessing to a plurality of services may be stored in the memory of the controller A. Examples of the services are as follows.

Service A

Account: aaa

Password: AAA

Necessity of account: YES

Service B

Account: bbb

Password: BBB

Necessity of account: YES

A CPU of the source device A that receives the account information from the controller A stores the received account information of the controller A in the share database. Actually, the share database is a memory of the devices A, B, and C. In case that the device A is the hose device, the CPU of the device A stores this account information as new share information in the memory, and distributes it to the other devices B and C. CPUs of the other devices B and C store the account information transmitted from the device A in the memories. In case that the device A is the client device, the CPU of the device A transmits the account information to the host device, and the host device distributes the account information to the other devices.

Further, the CPU of the source device A stores source device information representing that the self device is connected to the service server 100 in the share database. The source device information includes, for example, ID of the device A, and may include ID of the service A. The source device information is used for specifying the source device for connecting another device (the device B or the device C) to the service server 100.

After the account information and the source device information of the controller A are stored in the share database (namely, the account information and the source device information are stored as share information in the memories of the devices A, B, and C), when the user operates the controller A to select the service A (in the drawing, the internet radio service A), the selected information is transmitted from the controller A to the source device A. When the CPU of the source device A receives the selected information, it reads the account information related to the service A in the account information of the controller A from the share database, and accesses to the service server 100 using the read account information (sign in). Concretely, the CPU of the source device A reads the account information related to the service A in the account information as the share information stored in the memory so as to access to the service server 100. When the CPU of the source device A accesses to the service server 100, it downloads desired data such as audio data of an internet radio so as to reproduce it using an audio signal processor. Further, since the devices A, B, and C are connected by the network 10, the CPU of the source device A distributes the downloaded audio data also to another device B or C, so as to reproduce it in the device B or C.

Therefore, even if, for example, the devices A, B and C are arranged in different rooms, the user can enjoy the audio of the internet radio service A in all the rooms only through control of the source device A using the controller A.

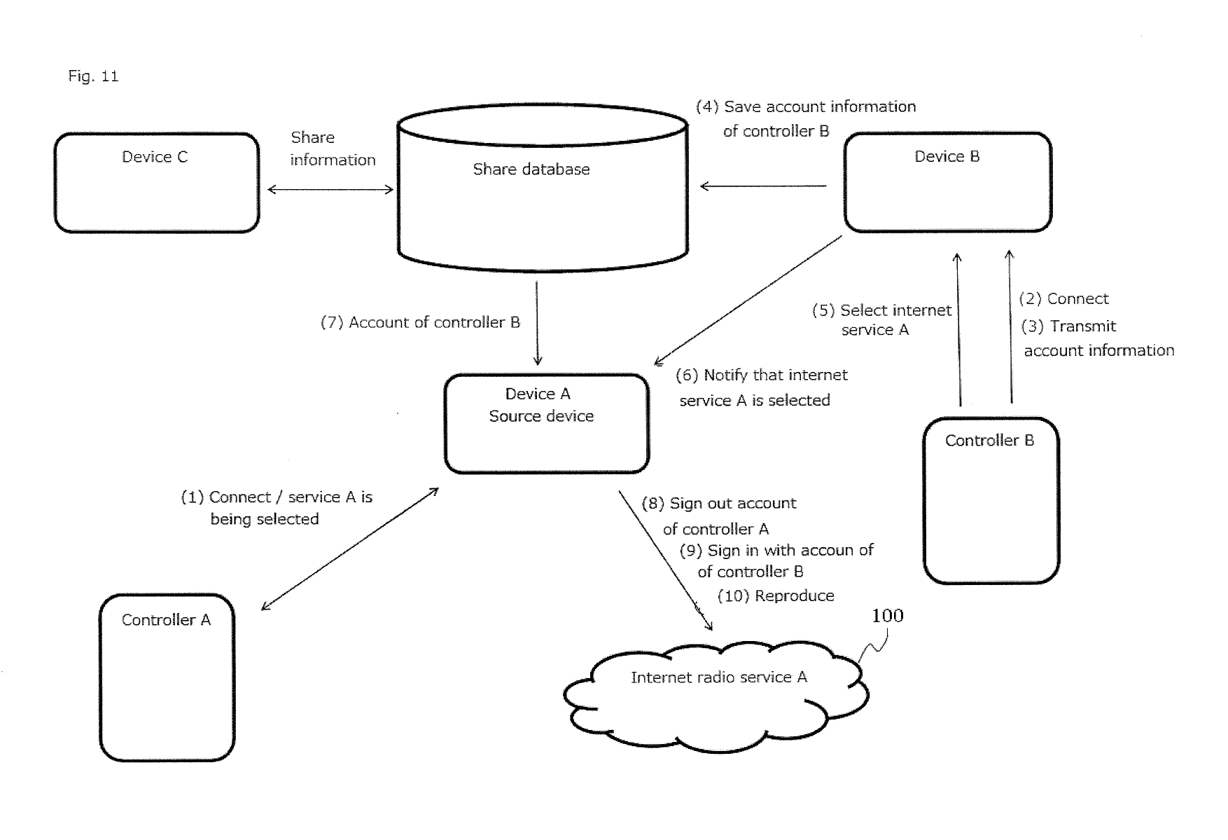

FIG. 11 illustrates a case where while the controller A is connected to the source device A and selects the service A, another controller B is connected to the device B. In this case, similarly to the case where the controller A is connected to the source device A, account information of the controller B is stored in the share database. The account information is stored in the memory of the controller B, and the controller B transmits the account information to the device B. Examples of the account information of the controller B are as follows.

Service A

Account: ddd

Password: DDD

Necessity of account: YES

Service B

Account: eee

Password: EEE

Necessity of account: YES

The CPU of the device B that receives the account information of the controller B stores the account information in the share database. Actually, the share database is memories of the devices A, B, and C. When the device B is the host device, the CPU of the device B stores this account information as new share information in the memory and distributes it to the other devices A and C. The CPUs of the other devices A and C store the account information transmitted from the device B in each of the memories. When the device B is the client device, the CPU of the device B transmits the account information to the host device, and the host device distributes the account information to the other devices. Therefore, the account information of the controller B as well as the account information of the controller A is stored in the share database.

Thereafter, when a user (a user different from the user who operates the controller A) operates the controller B to select the service A, the selected information is transmitted from the controller B to the device B. When receiving the selected information, the CPU of the device B refers to the share information, detects that the source device of the service A is the device A, and notifies the source device A of that the service A is selected. The CPU of the source device A that receives the notification from the device B reads the account information of the controller B from the share database according to this notification, and accesses to the service server 100 using the account information. In this case, during the access to the service server 100 using the account information of the controller A, the CPU of the source device A interrupts the access using the account information of the controller A if necessary (sign out), and carries out an access using the account information of the controller B (sign in). When the CPU of the source device A accesses to the service server 100, the audio data of the internet radio is downloaded so as to be reproduced by the audio signal processor. Further, the CPU of the source device A distributes the downloaded audio data also to the device B that receives notification, so that the device B reproduces the audio data.

In the present embodiment, it is considered that the device B that is connected to the controller B accesses to the service server 100 as a new source device, but it is unlikely that the access to the service server 100 is enabled due to a limitation of the device B. Further, even if the device B can access to the service server 100, this access is inefficient because the source device A has already accessed to the service server 100. Therefore, in case that the controller B requests the device B to select the service A and the source device A that has already downloaded the service A is present, it is suitable that the source device A is utilized. However, since the controller B is connected directly to the device B, it is difficult for the source device A to obtain the account information of the controller B.

On the contrary, in the present embodiment, the CPU of the device B stores the account information of the controller Bin the share database. For this reason, the CPU of the source device A can obtain the account information of the controller B only through the access to the share database. That is to say, the device A can access to the service server 100 as a proxy of (substitute for) the device B connected to the controller B.

In the present embodiment, it is noted that even if the device A that is not connected to the controller B is the source device A, the source device A easily obtains the account information of the controller B as the share information stored in the memory of the self device so as to be capable of accessing to the service server 100.

Further, in the present embodiment, the CPU of the source device A automatically makes switching into the account information of the controller B during the access to the service server 100 using the account information of the controller A so as to access to the service server 100. For this reason, the user can access to the service server 100 using the plurality of controllers without particularly being conscious about the switching of the account information. In case that the CPU of the source device A makes switching from the account information of the controller A into the account information of the controller B, the account information of the controller A may be allowed to remain in the share database. However, the account information of the controller A may be deleted from a viewpoint of security. That is to say, in case that the access to the service server 100 is interrupted, the account information used for that access may be deleted from the share database.

### <Sharing of Screen Information>

Sharing of screen information is described below.

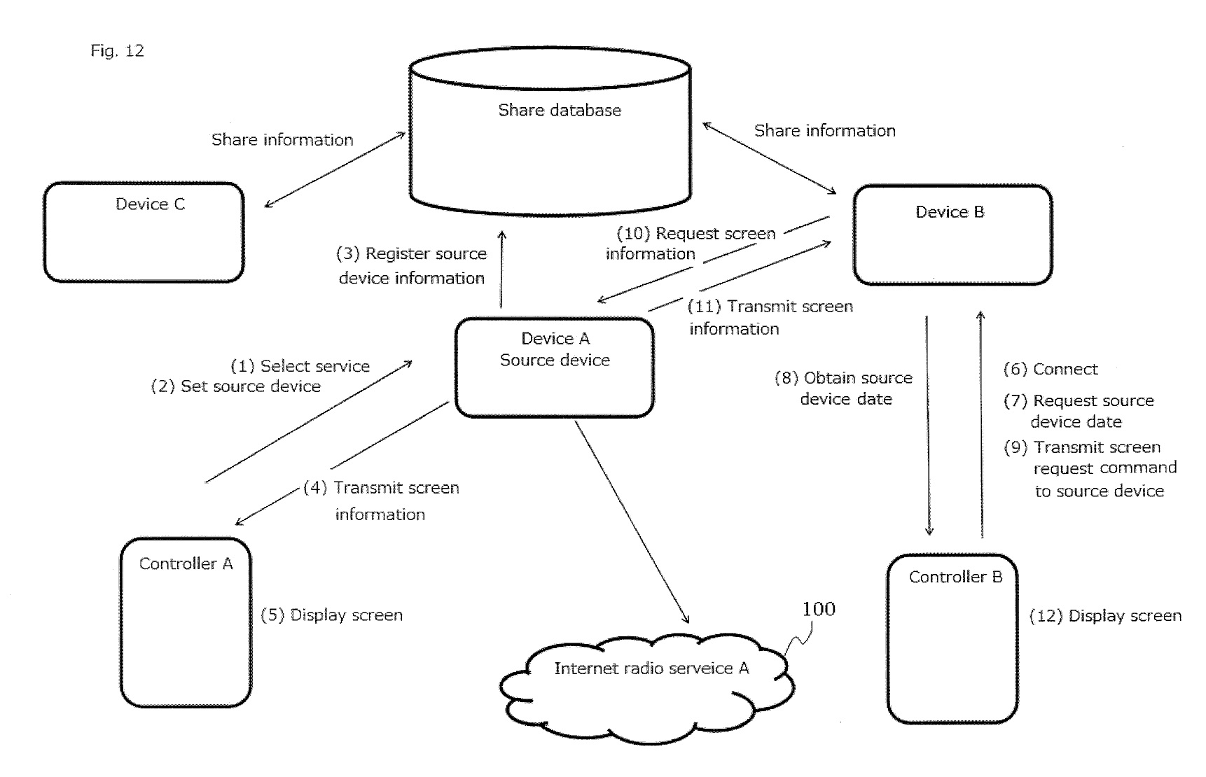

FIG. 12 illustrates a case where the controller A is connected to the source device A. The controller A sets the device A as the source device A so as to select the service A. The CPU of the source device A accesses to the service A of the service server 100 using the account information of the controller A as described above, and stores the account information of the controller A in the share database. Further, the CPU of the source device A stores source device information representing that the self device is the source device as to the service A as well as the account information in the share database. In this case, when the plurality of devices in the network system is divided into groups, the source device A may be related to a group so as to be stored in the share database. For example, in case that the device A and the device B form one group (this is a group 1), and the device C forms another group (this is a group 2), the source device information is as follows.

Group 1

Source device ID: ID of the device A

Participatory device: the device A and the device B

Service ID: A

Reproducing state: STOP

The CPU of the source device A further transmits screen information of the service A to the connected controller A. The controller A receives the screen information, and displays it on a screen.

On the other hand, while the controller A is connected to the source device A and the screen information is being displayed on the controller A, the controller B is connected to the device B. When the controller B requests source device data from the device B, the CPU of the device B accesses to the share database and determines whether the source device is present in the group to which the device B belongs. In case that the CPU of the device B determines that the source device information is present, it reads data of the source device (in this case, the source device A), and transmits it to the controller B. Concretely, the CPU of the device B reads data of the source device A retained as the share information in the memory, and transmits it to the controller B. The controller B receives the data transmitted from the device B so as to be capable of recognizing that the source device in the same group is the device A.

When the user operates the controller B to request the screen information of the service A, the controller B adds the ID of the device A as the source device to the screen request message, and transmits them to the device B. When the CPU of the device B receives this message, it requests the screen information from the device A based on the ID of the device A added to the message. The CPU of the device A returns the screen information identical to the screen information transmitted to the controller A according to the screen information request from the device B to the device B. The CPU of the device B returns the screen information from the device A to the controller B. The controller B receives the screen information from the device B, and displays it on the screen.

Even if the source device information representing that the source device is the device A is stored in the share database, and the controller B is connected to the device B different from the device A as the source device, the CPU of the device B requests the screen information from the device A based on the source device information so as to be capable of displaying the screen information identical to that of the controller A on the screen of the controller B, and thus convenience is improved. Further, since the screen information is not stored in the share database, namely, in the memory of the device, memory capacity can be reduced. Particularly, since the device is an acoustic device, the memory capacity is limited, and thus the effect of reduction in memory capacity is large.

Source device information that represents a device connected to the service server 100 in the devices A, B, and C is stored in the share database, so that the CPU of another device can easily detect the source device. In that case the controller is connected to a device that is not the source device and receives the request from the controller, the CPU of the device can transmit the request to the source device. Further, since not only the source device information but also the account information of the controller are stored as the share information, the CPU of the source device can be connected to the service server 100 easily using the account information. Further, even the controller connected to this device enables the user to visually recognize the screen identical to that of the controller connected to the source device.

The above has described the embodiment of the present invention, but the present invention is not limited to this and various modifications can be made.

For example, in the present embodiment, any one of the devices is set as the host device and the other devices are set as the client devices using the device list, but the host device may be set by another method. In other words, the host device is set by any method in the system where no server is present, and this host device distributes information to the other devices so that identical share information may be stored in the memories of each of the devices.

Further, in the present embodiment, in FIG. 10 and FIG. 11, the CPU of the source device A stores the account information of the controller A in the share database. The account information is used for a case where the source device A accesses to the service server 100, and also a case where when another device becomes a source device to be connected to another service server, it is connected to another service server according to the request from the controller A. For example, in case that the device B becomes the source device, the CPU of the source device B can be connected to the service server using the account information of the controller A stored in the share database.

Further, in FIG. 11, when the CPU of the source device A signs the service server 100 out using the account information of the controller A, the account information of the controller A is not immediately deleted from the share database but may be deleted after a predetermined period of time passes. For example, in case that a connecting request is not again transmitted from the controller A after a predetermined period of time passes, the CPU of the source device A may delete the account information of the controller A. Needless to say, when the CPU of the source device A stores the account information of the controller A in the share database, it prompts the controller A for whether registration of the account information is permitted. Only when the user operates the controller A for permission, the CPU of the source device A may store the account information in the share database.

Further, in FIG. 12, the CPU of the source device A transmits screen information to the device B according to the screen request from the device B. Also in this case, the CPU of the source device A prompts the controller A for whether the screen information is transmitted. Only when the user operates the controller A for permission, the controller A transmits the screen information to the device B, and the device B may transmit the screen information to the controller B.

Further, the screen information may include not only information displayed on the screen of the controller A but also various parameters necessary for displaying the screen. The various parameters may include parameters that are set by the user through the operation of the controller A.

The controller in the present embodiment can use any information terminal that can be connected to a device in a wired or wireless manner and can transmit a message or a command to the device, and a remote controller of an audio device, a tablet terminal or a smartphone may be used.

What is claimed is:

1. An information sharing system without a server comprising:
a plurality of network devices, wherein
each of the plurality of network devices includes
a processor,
a storage unit, and
a communication interface,
identical share information is stored in each of the storage units of the plurality of network devices,
when a first controller in a plurality of controllers is connected to a first network device of the plurality of network devices, the processor of the first network device connects to a service server, and distributes source device information representing the connection to the service server as share information to another network device via the communication interface,
when the second controller of the plurality of controllers is connected to a second network device of the plurality of network devices, the processor of the second network device reads the source device information as the share information from the storage unit, and processes a request from the second controller.

2. The information sharing system according to claim 1, wherein
the processor of the second network device distributes account information of the second controller as share information to another network device, and when receiving a request of connection to the service server from the second controller, the processor transmits the request of the connection to the service server to the first network device based on the source device information as the share information,
when receiving the request of connection to the service server from the processor of the second network device, the processor of the first network device makes the connection to the service server using the account information of the second controller as the share information.

3. The information sharing system according to claim 1, wherein
when receiving a screen request from the second controller, the processor of the second network device transmits the screen request to the first network device based on the source device information as the share information,
when receiving the screen request from the processor of the second network device, the processor of the first network device transmits screen information transmitted to the first controller to the second network device.

4. The information sharing system according to claim 1, wherein
the processor of any device of the plurality of network devices distributes information stored in the storage unit as share information to another device via the communication interface.
